(19) United States
(12) Patent Application Publication
(10) Pub. No.: US 2020/0166719 A1
(43) Pub. Date: May 28, 2020

(54) OPTICAL RECEPTACLE AND OPTICAL MODULE

(71) Applicant: Enplas Corporation, Saitama (JP)

(72) Inventor: Ayano KON, Saitama (JP)

(73) Assignee: Enplas Corporation, Saitama (JP)

(21) Appl. No.: 16/618,127

(22) PCT Filed: May 25, 2018
(86) PCT No.: PCT/JP2018/020140

§ 371 Date: Nov. 28, 2019

(30) Foreign Application Priority Data
May 31, 2017 (JP) 2017-108071

(51) Int. Cl. G02B 6/42

(52) U.S. Cl. CPC G02B 6/4286; G02B 6/4214

(57) ABSTRACT

This optical receptacle has a first optical surface on which light emitted from a light-emitting element is incident; a light splitting unit which splits the light incident on the first optical surface into monitor light that travels toward the detecting element and signal light that travels toward the cross-section of the optical transmission body; a second optical surface which emits the signal light split in the light splitting unit toward the cross-section of the optical transmission body; and a third optical surface which emits the monitor light split in the light splitting unit toward the detection element. The first optical surface causes the light incident thereon to converge so that the beam waist is positioned in the optical path between the first optical surface and the second optical surface.

### TECHNICAL FIELD

The present invention relates to an optical receptacle and an optical module.

### BACKGROUND ART

Conventionally, in optical communications using an optical transmission member such as an optical fiber and an optical waveguide, an optical module including a light emitting element such as a surface-emitting laser (e.g. a vertical-cavity surface-emitting laser (VCSEL)) has been used. Such an optical module includes an optical receptacle that operates such that light containing communication information emitted from a light emitting element is incident on an end surface of the optical transmission member.

In addition, for the purpose of adjusting the light output or stabilizing the output characteristics of a light emitting element against temperature variation, some optical modules include a detection element for checking (monitoring) the intensity and the quantity of the light emitted from the light emitting element.

For example, PTL 1 discloses an optical module including a photoelectric conversion device including a light emitting element and a detection element, and an optical receptacle configured to optically connect the light emitting element and an end surface of an optical transmission member.

The optical module disclosed in PTL 1 includes the photoelectric conversion device and the optical receptacle. The optical receptacle includes a first optical surface configured to allow incidence of light emitted from a light-emitting element, a light separation part configured to separate light entered from the first optical surface into monitor light travelling toward a detection device and signal light travelling toward an end surface of an optical transmission member, a perpendicular surface configured to allow signal light separated at the light separation part and emitted out of the optical receptacle to re-enter the optical receptacle, a second optical surface configured to emit the signal light incident on the perpendicular surface such that the light gathers at an end surface of the optical transmission member, and a third optical surface configured to emit the monitor light separated at the light separation part toward the detection device. In addition, the light separation part includes a divided reflection surface that is an inclined surface inclined to the optical axis of light reflected by the reflection surface and is configured to reflect a part of light reflected by the reflection surface toward the detection element, and a divided transmission surface that is a surface perpendicular to the optical axis and is configured to allow the other part of the light reflected by the reflection surface to pass therethrough toward the second optical surface.

In the optical module disclosed in PTL 1, the light emitted from the light-emitting element is entered from the first optical surface. The light having been entered from the first optical surface is converted to collimated light (parallel light), and is separated into signal light and monitor light by the light separation part. The signal light separated by the light separation part is emitted out of the optical receptacle, and then re-enters the optical receptacle from the perpendicular surface so as to be emitted from the second optical surface toward the end surface of the optical transmission member. The monitor light separated by the light separation part is emitted from the third optical surface toward the light reception surface of the detection element.

### CITATION LIST

### Patent Literature

PTL 1

### Japanese Patent Application Laid-Open No. 2013-137507

### SUMMARY OF INVENTION

### Technical Problem

With the above-mentioned optical module, however, a part of the light emitted from the light-emitting element may potentially be reflected by the interface of the light separation part and/or the perpendicular surface so as to be returned to the light-emitting element as return light. The return light to the light-emitting element becomes a noise source in the light emitted from the light-emitting element, and as such there is a demand for reducing the return light to the light-emitting element more than ever before.

To solve the above-mentioned problems, the present invention provides an optical receptacle capable of remarkably reducing return light to the light-emitting element. In addition, another object of the present invention is to provide an optical module including the optical receptacle.

### Solution to Problem

An optical receptacle according to an embodiment of the present invention is configured to be disposed between a photoelectric conversion device and one or more optical transmission members, the photoelectric conversion device including one or more light-emitting elements and one or more detection devices for monitoring emission light emitted from the one or more light-emitting elements, the optical receptacle being configured to optically couple the one or more light-emitting elements and an end surface of the one or more optical transmission members, the optical receptacle includes: one or more first optical surfaces configured to allow the light emitted from the one or more light-emitting elements to enter the optical receptacle; a light separation part configured to separate the light entered from the first optical surface into monitor light travelling toward the one or more detection devices and signal light travelling toward the end surface of the one or more optical transmission members; one or more second optical surfaces configured to emit, toward the end surface of the one or more optical transmission members, the signal light separated out by the light separation part; and one or more third optical surfaces configured to emit, toward the one or more detection devices, the monitor light separated out by the light separation part. The first optical surface converges the light entered from the first optical surface such that a beam waist of the light entered from the first optical surface is located on a light path between the first optical surface and the second optical surface.

An optical module according to an embodiment of the present invention includes: an photoelectric conversion device including a substrate, one or more light-emitting elements disposed on the substrate, and one or more detection devices disposed on the substrate, the one or more detection devices being configured to monitor emission light emitted from the one or more light-emitting elements; and the above-mentioned optical receptacle.

### Advantageous Effects of Invention

According to the present invention, it is possible to provide an optical receptacle capable of remarkably reducing return light to the light-emitting element, and an optical module including the optical receptacle.

### BRIEF DESCRIPTION OF DRAWINGS

FIG. 1 is a sectional view of an optical module according to the present embodiment;

FIGS. 2A to 2C illustrate a configuration of an optical receptacle according to the present embodiment;

FIGS. 3A and 3B illustrate a configuration of a light separation part;

FIG. 4 is a sectional view of a comparative optical module;

FIG. 5 illustrates light paths in the comparative optical module;

FIG. 6 illustrates light paths in the optical module according to the present embodiment;

FIG. 7 is a sectional view for description of a position of a beam waist of emission light emitted from a light-emitting element;

FIG. 8 illustrates a configuration of an optical module according to a modification; and

FIG. 9 illustrates a configuration of a light separation part according to a modification.

### DESCRIPTION OF EMBODIMENTS

An embodiment of the present invention is elaborated below with reference to the accompanying drawings.

Configuration of Optical Module

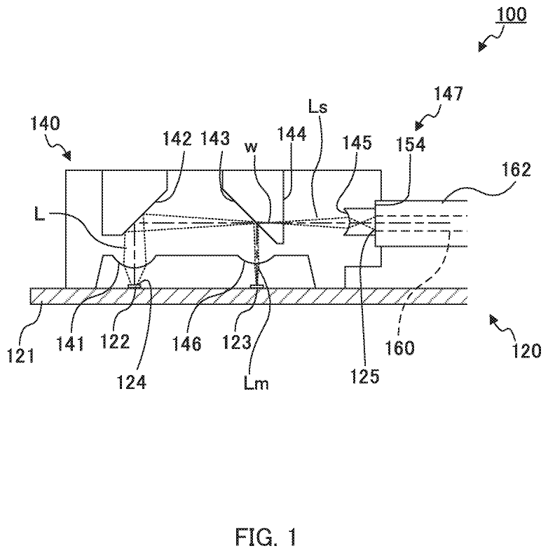

FIG. 1 is a sectional view of optical module 100 according to the present embodiment. FIG. 1 illustrates light paths in optical module 100. Note that, in FIG. 1, the hatching on the cross-section of optical receptacle 140 is omitted to illustrate light paths inside optical receptacle 140.

As illustrated in FIG. 1, optical module 100 includes photoelectric conversion device 120 of a substrate mounting type including light-emitting element 122, and optical receptacle 140. Optical module 100 is an optical module for transmission, and is used in the state where a plurality of optical transmission members 160 are coupled (or, in the following description, “connected”) to optical receptacle 140 through ferrule 162. The type of optical transmission member 160 is not limited, and optical transmission member 160 may be an optical fiber, a light waveguide or the like. In the present embodiment, a plurality of optical transmission members 160 are a plurality of optical fibers disposed in one line at a constant interval. The optical fiber may be of a single mode type, or a multiple mode type. Note that optical transmission members 160 may be disposed in two or more lines.

Photoelectric conversion device 120 includes substrate 121, twelve light-emitting elements 122, and twelve detection devices 123.

Substrate 121 is a flexible substrate, for example. Twelve light-emitting elements 122 and twelve detection devices 123 are disposed on substrate 121.

Light emitting element 122 is disposed on substrate 121, and emits laser light in a direction perpendicular to the installation part of substrate 121 where light emitting element 122 is disposed. The number of light emitting elements 122 is not limited. In the present embodiment, twelve light-emitting elements 122 are provided. In addition, the positions of light emitting element 122 are not limited. In the present embodiment, twelve light emitting elements are disposed in one line at a constant interval. Light emitting element 122 is a vertical-cavity surface-emitting laser (VCSEL), for example. Note that, when optical transmission members 160 are disposed in two or more lines, the number of the lines of light emitting elements 122 may be identical to that of optical transmission members 160.

Detection element 123 receives monitor light Lm for monitoring the output (e.g., the intensity and the quantity) of emission light L emitted from light emitting element 122. Detection element 123 is a photodetector, for example. The number of detection element 123 is not limited. In the present embodiment, twelve detection elements 123 are provided. Twelve detection elements 124 corresponding to twelve light emitting elements 122 are disposed in one line.

Optical receptacle 140 is disposed on substrate 121 of photoelectric conversion device 120. In the state where optical receptacle 140 is disposed between photoelectric conversion device 120 and optical transmission member 160, optical receptacle 140 optically connects light emitting surface 124 of light emitting element 122 and end surfaces 125 of a plurality of optical transmission members 160. A configuration of optical receptacle 140 is elaborated below.

Configuration of Optical Receptacle

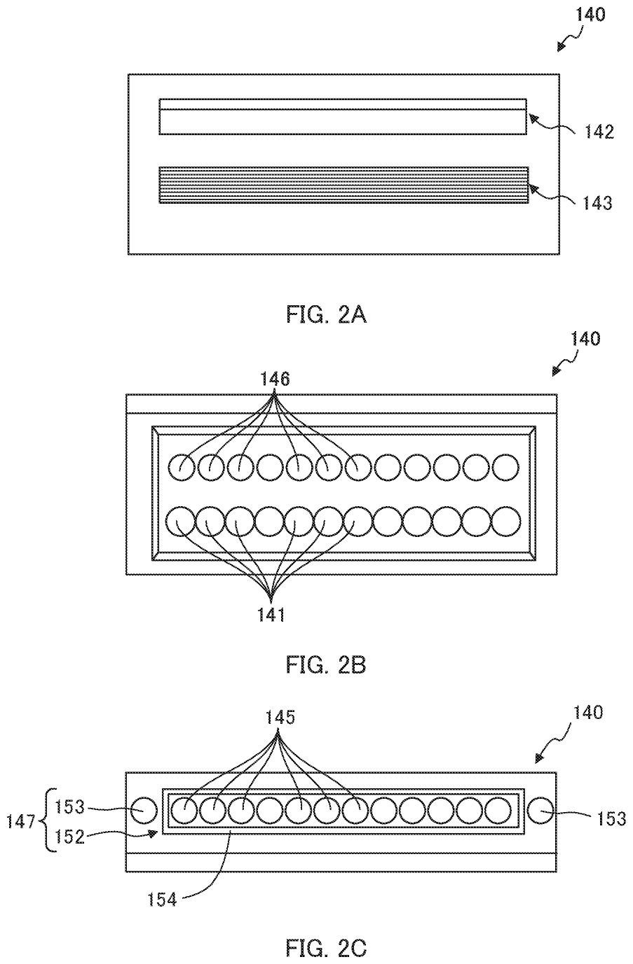

FIGS. 2A to 2C illustrate a configuration of optical receptacle 140 according to the present embodiment. FIG. 2A is a plan view of optical receptacle 140, FIG. 2B is a bottom view of optical receptacle 140, and FIG. 2C is a front view of optical receptacle 140.

As illustrated in FIG. 1 and FIGS. 2A to 2C, optical receptacle 140 is a member having a substantially cuboid shape. Optical receptacle 140 is optically transparent, and emits emission light L emitted from light-emitting surface 124 of light-emitting element 122 toward end surface 125 of optical transmission member 160. Optical receptacle 140 includes a plurality of first optical surfaces 141, reflection surface 142, light separation part 143, fourth optical surface 144, a plurality of second optical surfaces 145, a plurality of third optical surfaces 146 and fixing part 147. Optical receptacle 140 is formed using a material having a transparency to light of the wavelength used in optical communications. Examples of such a material include transparent resins such as polyetherimide (PEI) and cyclic olefin resin. In addition, for example, optical receptacle 140 is manufactured by injection molding.

First optical surface 141 is an optical surface that allows emission light L emitted from light-emitting element 122 to enter optical receptacle 140 while refracting emission light L. Then, first optical surface 141 converges the light entered from first optical surface 141 such that beam waist w is located on the light path between first optical surface 141 and second optical surface 145. With such a configuration, the light reflected by light separation part 143, fourth optical surface 144 and/or the like expands as the light approaches light-emitting element 122, and thus return light to light-emitting element 122 can be reduced. Beam waist w is a portion having a smallest light flux diameter.

For the purpose of further reducing the return light to light-emitting element 122, preferably, first optical surface 141 converges the light entered from first optical surface 141 such that beam waist w is located on the light path between first optical surface 141 and fourth optical surface 144, or more preferably, first optical surface 141 converges the light entered from first optical surface 141 such that beam waist w is located on the light path between first optical surface 141 and fourth optical surface 144 in a region other than the region on the light separation part.

In the present embodiment, first optical surface 141 has a shape of a convex lens protruding toward light emitting element 122. The position of beam waist w of the light entered from first optical surface 141 can be adjusted by the curvature of the convex lens surface that is first optical surface 141. For example, the position of beam waist w of the light entered from first optical surface 141 can be moved away from light-emitting element 122 by reducing the curvature of the convex lens, and the position can be moved closer to light-emitting element 122 by increasing the curvature of the convex lens.

In addition, in the present embodiment, a plurality of (twelve) first optical surfaces 141 are disposed in one line in the long side direction on the bottom surface of optical receptacle 140 in such a manner as to face light emitting surface 124 of light emitting element 122. In addition, first optical surface 141 has a circular shape in plan view. The light entered from first optical surface 141 advances toward light separation part 142. Note that when light emitting elements 122 are arranged in two or more lines, the number of the lines of first optical surfaces 141 is identical to that of light emitting elements 122.

Reflection surface 142 is an inclined surface formed on the top surface side of the optical receptacle 140. Reflection surface 142 reflects, toward light separation part 143, emission light L entered from first optical surface 141. Reflection surface 142 is tilted such that the distance to optical transmission member 160 decreases in the direction from the bottom surface toward the top surface of optical receptacle 140. In the present embodiment, the inclination angle of reflection surface 142 is 45 degrees with respect to the optical axis of emission light L entered from first optical surface 141. Emission light L entered from first optical surface 141 internally impinges on reflection surface 142 at an incident angle greater than the critical angle. In this manner, reflection surface 142 totally reflects incident emission light L in the direction along the surface of substrate 121.

Light separation part 143 separates the light entered from first optical surface 141 (emission light L emitted from light-emitting element 122) into monitor light Lm travelling toward detection device 123 and signal light Ls travelling toward the second optical surface (end surface 125 of optical transmission member 160). Light separation part 143 is a region composed of a plurality of surfaces, and is disposed on the top surface side of optical receptacle 140.

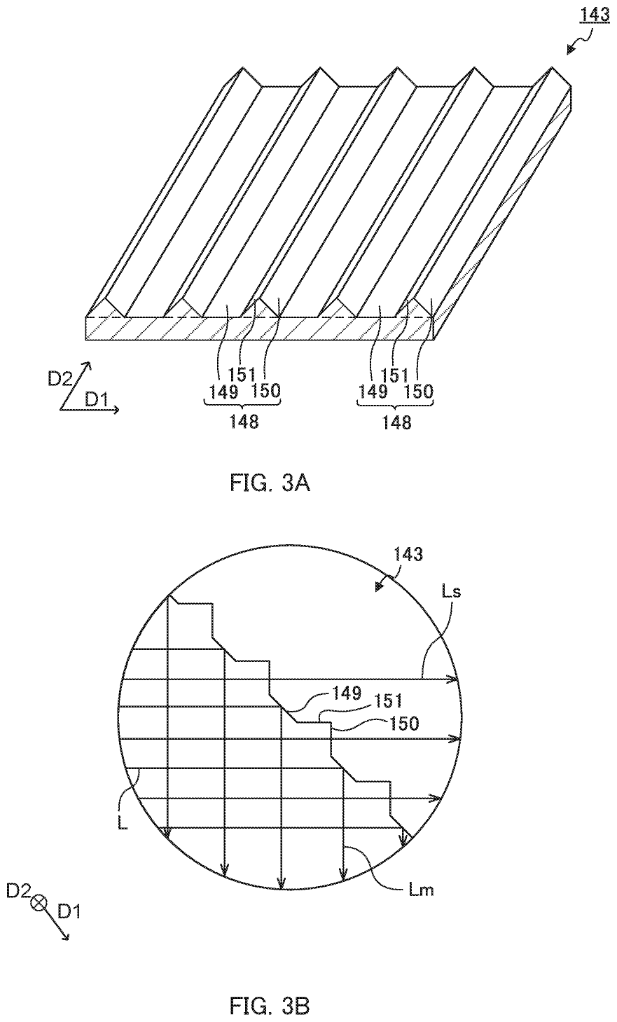

FIGS. 3A and 3B illustrate a configuration of light separation part 143. FIG. 3A is a perspective view of light separation part 143, and FIG. 3B is a partially enlarged sectional view illustrating light paths in light separation part 143. In FIG. 3B, the hatching of the cross section of optical receptacle 140 is omitted to illustrate light paths in optical receptacle 140.

As illustrated in FIG. 3, light separation part 143 includes a plurality of separation units 148. While the number of separation units 148 is not limited, four to six separation units 148 are disposed in the region where emission light L incident on first optical surface 141 reaches. Each separation unit 148 includes one divided reflection surface 149, one divided transmission surface 150 and one divided step surface 151. In other words, light separation part 143 includes a plurality of divided reflection surfaces 149, a plurality of divided transmission surfaces 150, and a plurality of divided step surfaces 151. In the following description, the inclination direction of divided reflection surface 149 is referred to as first direction D1 (see arrow D1 of FIG. 1 and FIGS. 3A and 3B). Divided reflection surfaces 149, divided transmission surfaces 150 and divided step surfaces 151 are divided in first direction D1.

Divided reflection surface 149 is an inclined surface that is inclined to the optical axis of emission light L entered from first optical surface 141. Divided reflection surface 149 reflects, toward third optical surface 146, a part of emission light L incident on first optical surface 141. In the present embodiment, divided reflection surface 149 is tilted such that the distance to second optical surface 145 (optical transmission member 160) decreases in the direction from the top surface toward the bottom surface of optical receptacle 140. The inclination angle of divided reflection surface 149 is 45 degrees to the optical axis of emission light L entered from first optical surface 141. Divided reflection surfaces 149 are spaced in first direction D1 and disposed at a predetermined interval. Divided reflection surfaces 149 are parallel to each other in first direction D1.

Divided transmission surface 150 is a surface perpendicular to the optical axis of emission light L entered from first optical surface 141. Divided transmission surface 150 is formed at a position different from that of divided reflection surface 149. Divided transmission surface 150 allows a part of emission light L entered from first optical surface 141 to pass therethrough, and emits the light to the outside of optical receptacle 140 (see FIG. 1). Divided transmission surface 150 is also divided in first direction D1 at a predetermined interval. Divided transmission surfaces 150 are parallel to each other in first direction D1.

Divided step surface 151 is disposed between divided reflection surface 149 and divided transmission surface 150, and is parallel to the optical axis of emission light L entered from first optical surface 141. Divided step surface 151 is divided in first direction D1 into a plurality of surfaces that are disposed at a predetermined interval. Divided transmission surfaces 150 are parallel to each other in first direction D1.

In each separation unit 148, divided reflection surface 149, divided step surface 151 and divided transmission surface 150 are arranged in this order in the first direction D1 (the direction from the top surface toward the bottom surface). The smaller angle of the angles between divided reflection surface 149 and divided step surface 151 is 135 degrees. In addition, the smaller angle of the angles between divided reflection surface 149 and divided transmission surface 150 (of adjacent separation unit 148) is 135 degrees. In light separation part 143, a plurality of separation units 148 are arranged in first direction D1.

As illustrated in FIG. 3B, a part of emission light L entered from first optical surface 141 internally impinges on division reflection surface 149 at an incident angle greater than the critical angle. Divided reflection surface 149 reflects, toward third optical surface 146, a part of emission light L entered from first optical surface 141 to thereby generate monitor light Lm. On the other hand, divided transmission surface 150 allows a part of emission light L entered from first optical surface 141 to pass therethrough, and generates signal light Ls travelling toward end surface 125 of optical transmission member 160. At this time, signal light Ls is emitted without being refracted since divided transmission surface 150 is perpendicular to emission light L.

The ratio between the quantity of signal light Ls and the quantity of monitor light Lm is not limited as long as monitor light Lm capable of monitoring the intensity and the quantity of light L emitted from light emitting element 122 can be obtained while ensuring a desired quantity of signal light Ls. Preferably, the quantity ratio between signal light Ls and monitor light Lm is signal light Ls:monitor light Lm=6:4 to 8:2. More preferably, the quantity ratio between signal light Ls and monitor light Lm is signal light Ls:monitor light Lm=7:3.

Fourth optical surface 144 is disposed on the top surface side in optical receptacle 140, and is approximately perpendicular to the optical axis of signal light Ls separated by light separation part 143. The substantially perpendicular surface means a surface whose angle to the line perpendicular to the optical axis of signal light Ls separated by light separation part 143 is ±5 degrees or smaller, preferably 0 degree. Fourth optical surface 144 allows signal light Ls separated and emitted out of optical receptacle 140 by light separation part 143 to re-enter optical receptacle 140. With this configuration, it is possible to allow signal light Ls travelling toward end surface 125 of optical transmission member 160 to re-enter optical receptacle 140 without refracting the light.

Second optical surface 145 is an optical surface that emits, toward end surface 125 of optical transmission member 160, signal light Ls separated by light separation part 143 (in the present embodiment, signal light Ls that has re-entered optical receptacle 140 from fourth optical surface 144 after being separated and emitted out of optical receptacle 140 by light separation part 143). In the present embodiment, a plurality of second optical surfaces 145 are disposed in one line in the long side direction on the front surface of optical receptacle 140 in such a manner as to face end surface 125 of optical transmission member 160. Second optical surface 144 has a shape of a convex lens protruding toward end surface 125 of optical transmission member 160. With this configuration, signal light Ls entered from first optical surface 141 and separated at light separation part 143 can be condensed and efficiently connected to end surface 125 of optical transmission member 160. Note that, in the case where optical transmission members 160 are disposed in two or more lines, the number of the lines of second optical surfaces 145 is identical to that of optical transmission members 160.

Third optical surface 146 is disposed on the bottom surface side of optical receptacle 140 in such a manner as to face detection element 123. In the present embodiment, third optical surface 146 is a convex lens surface protruding toward detection device 123. Third optical surface 146 causes convergence of monitor light Lm separated at light separation part 143, and emits it toward detection element 123. In this manner, it is possible to efficiently couple monitor light Lm to detection element 123. Preferably, the central axis of third optical surface 146 is perpendicular to the light reception surface (substrate 121) of detection element 123.

Fixing part 147 fixes, at a predetermined position of optical receptacle 140, end surface 125 of optical transmission member 160 held by ferrule 162. Fixing part 147 fixes optical transmission member 160 such that signal light Ls emitted from second optical surface 145 reaches end surface 125 of optical transmission member 160 at a position farther than a focus of the second optical surface 145. Fixing part 147 is disposed on the front surface of optical receptacle 140 and includes positioning recess 152 and positioning hole 153 (see FIG. 2C). Positioning recess 152 is disposed at a center portion on the front surface of optical receptacle 140. In addition, second optical surfaces 145 are disposed on the bottom of positioning recess 152. The shape of positioning recess 152 in plan view is not limited. In plan view, the shape of positioning recess 152 and the shape of ferrule 162 are similar to each other. Step 154 for setting the position of ferrule 162 is disposed in positioning recess 152. Step 154 is formed to protrude to the inside from the inner wall of positioning recess 152. In addition, positioning hole 153 is disposed at outer end portions of positioning recess 152 in the long side direction in such a manner as to correspond to a positioning protrusion (omitted in the drawing) of ferrule 162. The positioning protrusion of ferrule 162 is inserted to positioning hole 153 of optical receptacle 140. With this configuration, when the positioning protrusion of ferrule 162 is inserted to positioning hole 153 of optical receptacle 140 and an end surface of ferrule 162 is brought into contact with step 154, ferrule 162 (end surface 125 of optical transmission member 160) is positioned and fixed to optical receptacle 140.

In comparison with conventional optical modules, optical module 100 according to the present embodiment reduces the ratio of light (return light) that returns to light-emitting element 122 after being reflected by light separation part 143, fourth optical surface 144 and/or the like, to emission light L emitted from light-emitting element 122. A conceivable reason for this is as follows.

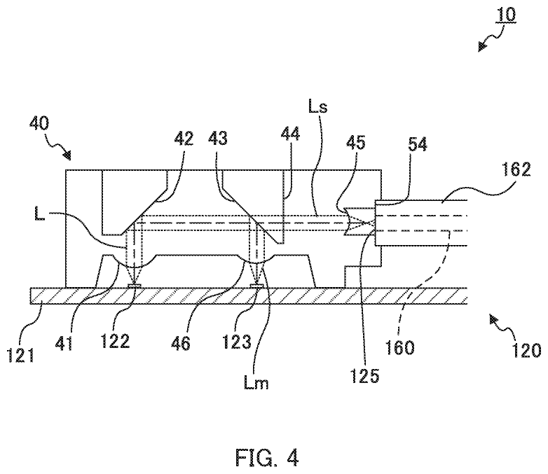

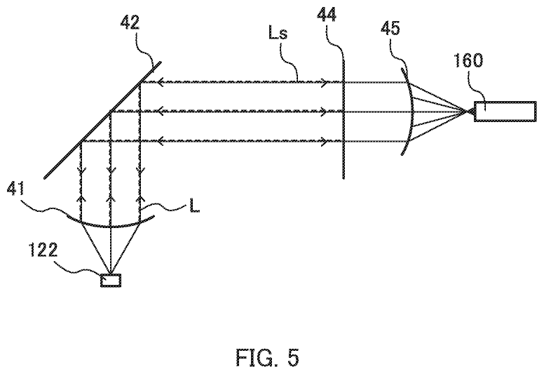

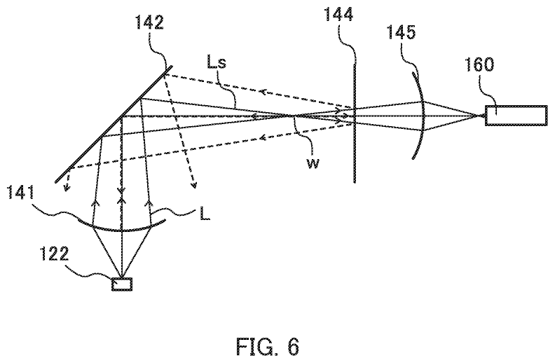

FIG. 4 is a sectional view of comparative optical module 10. FIG. 5 illustrates light paths in comparative optical module 10. FIG. 6 illustrates light paths in optical module 100 according to the present embodiment. An example of reflection at fourth optical surface 44 or 144 is described below. For such a purpose, FIG. 5 and FIG. 6 illustrate light-emitting element 122, first optical surface 41 or 141, reflection surface 42 or 142, fourth optical surface 44 or 144, second optical surface 45 or 145, and optical transmission member 160.

As illustrated in FIG. 4, in comparative optical module 10, emission light L emitted from light-emitting element 122 first enters optical receptacle 40 from optical surface 41. The light entered from first optical surface 41 is converted to collimated light and reflected by reflection surface 42, and then the light is separated by light separation part 43 into monitor light Lm travelling toward detection device 123 and signal light Ls travelling toward optical transmission member 160. Monitor light Lm travelling toward detection device 123 is emitted from third optical surface 46 and reaches detection device 123. On the other hand, signal light Ls travelling toward optical transmission member 160 is emitted out of optical receptacle 40, and then re-enters optical receptacle 40 from fourth optical surface 44. The light re-entered optical receptacle 40 from fourth optical surface 44 is emitted from second optical surface 45, and reaches end surface 125 of optical transmission member 160.

At this time, as illustrated in FIG. 5, a part of signal light Ls separated by light separation part 43 and delivered toward optical transmission member 160 (see the solid arrow) is reflected by fourth optical surface 44. The light reflected by fourth optical surface 44 (see the dotted line arrow) travels as light (collimated light) parallel to the optical axis, and a part of such light is transmitted through separation part 43 and reflected by reflection surface 42, and thereafter, emitted from first optical surface 41 as return light toward light-emitting element 122. In this manner, the light reflected by fourth optical surface 44 travels as collimated light, and as such almost all of the light transmitted through light separation part 43 tends to return to light-emitting element 122.

In contrast, as illustrated in FIG. 1, in optical module 100 according to the present embodiment, emission light L emitted from light-emitting element 122 enters optical receptacle 140 from first optical surface 141. The light entered from first optical surface 141 is converted to light that converges such that beam waist w is located on the light path between first optical surface 141 and second optical surface 145. Then, the light is reflected by reflection surface 142, and thereafter separated by light separation part 143 into monitor light Lm travelling toward detection device 123 and signal light Ls travelling toward optical transmission member 160. Monitor light Lm travelling toward detection device 123 is emitted from third optical surface 146, and reaches detection device 123. On the other hand, signal light Ls travelling toward optical transmission member 160 is emitted from optical receptacle 140 and re-enters optical receptacle 140 from fourth optical surface 144. The light having re-entered optical receptacle 140 from fourth optical surface 144 is emitted from second optical surface 145, and reaches end surface 125 of optical transmission member 160.

At this time, as illustrated in FIG. 6, a part of signal light Ls separated by light separation part 143 and delivered toward optical transmission member 160 (see the solid arrow) is reflected by fourth optical surface 144. The light reflected by fourth optical surface 144 (see the dotted line arrow) advances as light (scattered light) expanding in the direction away from the optical axis, and a part of such light is transmitted through light separation part 143 and reflected by reflection surface 142, and thereafter, emitted from first optical surface 144 as return light toward light-emitting element 122. In this manner, the signal light reflected by fourth optical surface 144 travels as scattered light, and accordingly a part of the light transmitted through light separation part 143 tends to be scattered in the direction away from the optical axis. Thus, the light that returns to light-emitting element 122 can be reduced.

### Simulation

The ratio of light (return light) that returns to light-emitting element 122 after being reflected by each optical surface (end surface 125 of optical transmission member 160, second optical surface 145, fourth optical surface 144, light separation part 143, and first optical surface 141), to the quantity of light emitted from light-emitting element 122 was simulated while changing the position of beam waist w of emission light L emitted from light-emitting element 122.

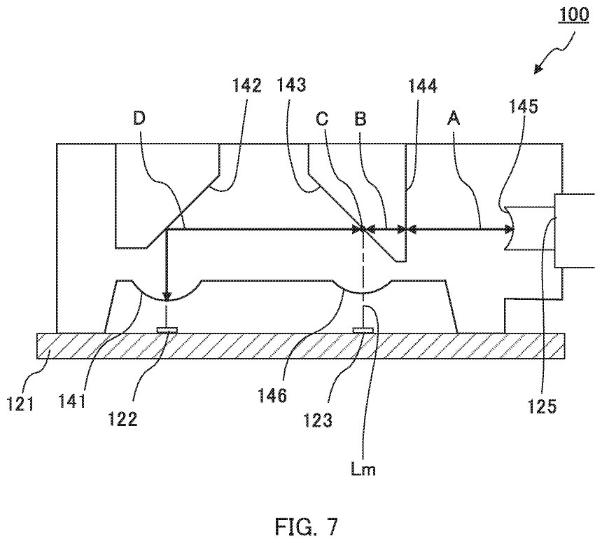

FIG. 7 is a sectional view for description of the position of beam waist w of emission light L emitted from light-emitting element 122. As illustrated in FIG. 7, the ratio (%) of the return light to emission light L emitted from light-emitting element 122 was simulated using analysis software with optical module 100 (see FIG. 1) using optical receptacle 1 according to the present embodiment in which beam waist w of emission light L emitted from light-emitting element 122 is located between second optical surface 145 and fourth optical surface 144 (section A), optical receptacle 2 according to the present embodiment in which beam waist w of emission light L emitted from light-emitting element 122 is located between fourth optical surface 144 and light separation part 143 (section B), optical receptacle 3 according to the present embodiment in which beam waist w of emission light L emitted from light-emitting element 122 is located on light separation part 143 (on section C), and optical receptacle 4 according to the present embodiment in which beam waist w of emission light L emitted from light-emitting element 122 is located between light separation part 143 and first optical surface 141 (section D).

In addition, for comparison, the same simulation was conducted with optical module 10 (see FIG. 4) using comparative optical receptacle 5 in which emission light L emitted from light-emitting element 122 becomes collimated light (with no beam waist w).

A vertical-cavity surface-emitting laser (VCSEL) having a numerical aperture (NA) of 0.25 and a light emission diameter of φ8 μm was used as light-emitting element 122 for the simulation. An optical fiber having a numerical aperture (NA) of 0.20 and a core diameter of φ50 μm was used as optical transmission member 160. Table 1 shows results of the simulation.

TABLE 1

| | Embodiment | | | | Comparative example |
|---|---|---|---|---|---|
| Optical receptacle No. | 1 | 2 | 3 | 4 | 5 |
| Type of emission light L | Converging light | | | | Collimated light |
| Position of beam waist w of | Section A | Section B | Section C | Section D | — |
| emission light L | | | | | |
| End surface 125 of optical | 1.20% | 0.00% | 0.00% | 0.00% | 1.00% |
| transmission member 160 | | | | | |
| Second optical surface 145 (45) | 0.02% | 0.00% | 0.00% | 0.00% | 0.00% |
| Fourth optical surface 144 (44) | 2.60% | 0.00% | 0.00% | 0.00% | 2.09% |
| Light separation part 143 (43) | 0.43% | 0.39% | 1.08% | 0.59% | 2.42% |
| First optical surface 141 (41) | 0.00% | 0.00% | 0.00% | 0.00% | 0.00% |
| Sum of ratio of return light | 4.25% | 0.39% | 1.08% | 0.59% | 5.51% |

As shown in Table 1, in optical receptacles 1 to 4 according to the present embodiment, the ratio of the light returned to light-emitting element 122 is smaller than in comparative optical receptacle 5. A conceivable reason for this is that light reflected by fourth optical surface 144 and/or divided transmission surface 150 of light separation part 143 expands as it approaches light-emitting element 122.

In particular, in optical receptacles 2 to 4 in which beam waist w is located in or on section B, section C or section D, the ratio of the light returned to light-emitting element 122 is further smaller than in optical receptacle 1 in which beam waist w is located in section A. A conceivable reason for this is that in optical receptacle 1 in which beam waist w is located in section A, the signal light reflected by fourth optical surface 144 converges and then expands and therefore the expansion angle is relatively small, whereas in optical receptacles 2 to 4 in which beam waist w is located in or on section B, section C or section D, the signal light reflected by fourth optical surface 144 expands without converging, and therefore the expansion angle is relatively large. Further, in optical receptacles 2 and 4 in which beam waist w is not located on section C the ratio of the light returned to light-emitting element 122 is further smaller then in optical receptacle 3 in which beam waist w is located on C.

Effect

As described above, in optical module 100 according to the present embodiment, first optical surface 141 of optical receptacle 140 is configured to converge the light entered from first optical surface 141 such that beam waist w is located on the light path between first optical surface 141 and second optical surface 145. With this configuration, light reflected by light separation part 143, fourth optical surface 144 and/or the like can be expanded as it approaches light-emitting element 122, and the return light to light-emitting element 122 can be reduced. Thus, the return light can be reduced by only changing the structure of first optical surface 141 without providing attenuation coating to optical receptacle 140 or significantly changing the structure of light separation part 143.

Note that while optical receptacle 140 includes reflection surface 142 in the present embodiment in FIG. 1, this is not limitative.

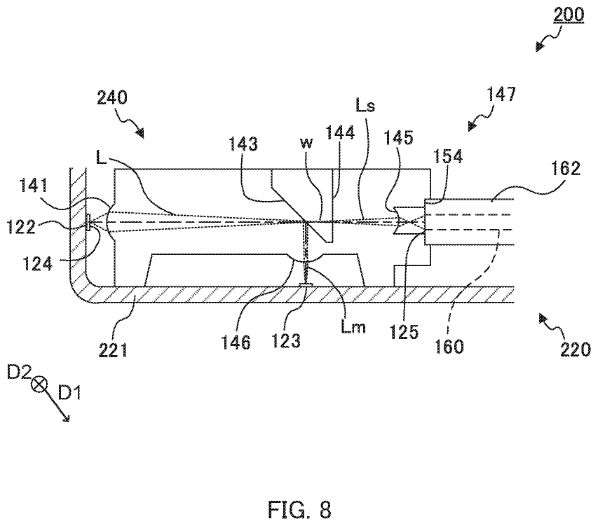

FIG. 8 is a sectional view of optical module 200 according to a modification. As illustrated in FIG. 8, optical module 200 includes photoelectric conversion device 220 including light-emitting element 122, and optical receptacle 240. Optical receptacle 240 may have a configuration same as that of the optical receptacle of FIG. 1 except that first optical surface 141 is disposed in the back surface of optical receptacle 240 and that reflection surface 142 is not provided. Substrate 221 of photoelectric conversion device 220 is disposed such that light-emitting element 122 faces first optical surface 141 of optical receptacle 240 and that detection device 123 faces third optical surface 146 of optical receptacle 240.

While each of twelve first optical surfaces 141 is used as the first optical surface for transmission (optical module 100 is used as an optical module for transmission) in the present embodiment in FIG. 2B, this is not limitative. For example, each of twelve first optical surfaces 141 may be used as the first optical surface for reception (optical module 100 may be used as optical module for reception), or six first optical surfaces 141 on the right side or the left side may be used as first optical surfaces 141 for reception (optical module 100 may be used for transmission and reception).

While separation unit 148 of light separation part 143 includes divided step surface 151 in the present embodiment in FIG. 3, this is not limitative, and divided step surface 151 may not be provided.

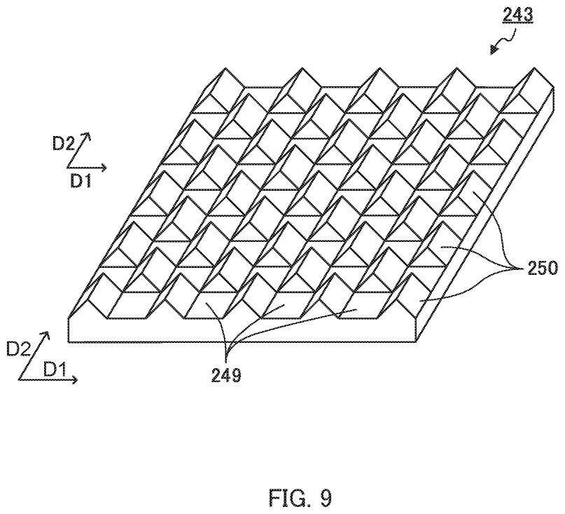

In addition, as illustrated in FIG. 9, the separation units of light separation part 143 may be alternately disposed in first direction D1 and second direction D2 orthogonal to first direction D1 in a matrix. Here “second direction” is the direction D2 that extends along divided reflection surface 249 and is orthogonal to first direction D1 (see arrow D2 illustrated in FIG. 9).

While light separation part 143 includes a plurality of separation units 148 in the present embodiment, this is not limitative, and for example, it may be composed of a half mirror.

This application is entitled to and claims the benefit of Japanese Patent Application No. 2017-108071 filed on May 31, 2017, the disclosure each of which including the specification, drawings and abstract is incorporated herein by reference in its entirety.

### INDUSTRIAL APPLICABILITY

The optical receptacle and the optical module according to the embodiment of the present invention are suitable for optical communications using an optical transmission member.

### REFERENCE SIGNS LIST

100, 200 Optical module
120, 220 Photoelectric conversion device
121, 221 Substrate
122 Light-emitting element
123 Detection device
124 Light-emitting surface
125 End surface
140, 240 Optical receptacle
141 First optical surface
142 Reflection surface
143, 243 Light separation part
144 Fourth optical surface
145 Second optical surface
146 Third optical surface
147 Fixing part
148 Separation unit
149, 249 Divided reflection surface
150 Divided transmission surface
151 Divided step surface
152 Positioning recess
153 Positioning hole
154 Step
160 Optical transmission member
162 Ferrule
w Beam waist
L Emission light
Lm Monitor light
Ls Signal light

1. An optical receptacle configured to be disposed between a photoelectric conversion device and one or more optical transmission members, the photoelectric conversion device including one or more light-emitting elements and one or more detection devices for monitoring emission light emitted from the one or more light-emitting elements, the optical receptacle being configured to optically couple the one or more light-emitting elements and an end surface of the one or more optical transmission members, the optical receptacle comprising:
one or more first optical surfaces configured to allow the light emitted from the one or more light-emitting elements to enter the optical receptacle;
a light separation part configured to separate the light entered from the first optical surface into monitor light travelling toward the one or more detection devices and signal light travelling toward the end surface of the one or more optical transmission members;
one or more second optical surfaces configured to emit, toward the end surface of the one or more optical transmission members, the signal light separated out by the light separation part; and
one or more third optical surfaces configured to emit, toward the one or more detection devices, the monitor light separated out by the light separation part,
wherein the first optical surface converges the light entered from the first optical surface such that a beam waist of the light entered from the first optical surface is located on a light path between the first optical surface and the second optical surface.

2. The optical receptacle according to claim 1, further comprising a fourth optical surface disposed on a light path between the light separation part and the second optical surface, the fourth optical surface being configured to allow, to re-enter the optical receptacle, signal light separated by the light separation part and emitted out of the optical receptacle,
wherein the first optical surface converges the light entered from the first optical surface such that the beam waist of the light entered from the first optical surface is located on a light path between the first optical surface and the fourth optical surface.

3. The optical receptacle according to claim 2, wherein the beam waist is not located on the light separation part.

4. The optical receptacle according to claim 1,
wherein the light separation part includes a plurality of separation units, each separation unit including a divided reflection surface tilted to an optical axis of the light entered from the first optical surface, and a divided transmission surface perpendicular to the optical axis;
wherein the divided reflection surface and the divided transmission surface are arranged in a first direction, the first direction being an inclination direction of the divided reflection surface;
wherein the plurality of separation units are arranged in the first direction;
wherein a plurality of the divided reflection surfaces reflect, toward the third optical surface as the monitor light, a part of the light entered from the first optical surface; and
wherein a plurality of the divided transmission surfaces allow, to pass through the plurality of the divided transmission surfaces as the signal light, another part of the light entered from the first optical surface.

5. The optical receptacle according to claim 1, further comprising a reflection surface disposed on a light path between the first optical surface and the light separation part, the reflection surface being configured to reflect, toward the light separation part, the light entered from the first optical surface.

6. An optical module comprising:
an photoelectric conversion device including a substrate, one or more light-emitting elements disposed on the substrate, and one or more detection devices disposed on the substrate, the one or more detection devices being configured to monitor emission light emitted from the one or more light-emitting elements; and
the optical receptacle according to claim 1.
